(19) United States
(12) Patent Application Publication
(10) Pub. No.: US 2010/0047525 A1
(43) Pub. Date: Feb. 25, 2010

(54) Film structure and a manufacturing method thereof

(76) Inventors: Hsin Yuan Chen, Minsyong Township (TW); Yu-Yun Hsieh, Sansia Township (TW); Shan-Er Hsieh, Chenggong Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/222,927

(22) Filed: Aug. 20, 2008

(51) Int. Cl. B32B 5/16; B32B 38/00

(52) U.S. Cl. 428/147; 156/242

(57) ABSTRACT

A film structure and a manufacturing method thereof are applied to the in-mold decoration process. First, at least two kinds of flexible resin particles are applied on the upper surface of a film. The two kinds of flexible resin particles include first resin particles for increasing the tissue-type feeling and second resin particles for enhancing the anti-wear effect. Next, an ink layer is formed on the lower surface of the film. A heating process is used for forming the film into a pre-determined shape, and an injection molding process is used for forming a plastic substrate and the plastic substrate is pasted below the ink layer. Finally, UV light is used for hardening the coating layer. Thereby, the film has the tissue-type feeling and the anti-wear effect.

### BACKGROUND OF THE INVENTION

1. Field of the Invention

The present invention relates to a film structure and a manufacturing method thereof. In particular, this invention relates to a film structure and a manufacturing method thereof that is applied to the in-mold decoration manufacturing process and has a tissue-type feeling and anti-wear characteristics.

2. Description of the Related Art

Because technology products are popular in the daily life of many people, both the functions and the appearance of the products are improved to meet the people requirements.

The appearance of colored products of the prior art usually is implemented by an ink color process. Because the ink layer of the products is often used as a protection layer for the products, the ink layer becomes worn so that its color may fade or blur. Furthermore, the ink layer may fall off leaving the products without protection layer.

The ink color process is implemented by spraying colored ink on the surface of the products to generate patterns or colors. When the ink is sprayed, several layers need to be applied, which can lead to misalignment if patterns are complex. If a tissue-type feeling is added, a spraying process with a nap coating is required. The thickness of the coating is not uniform, and an orange skin symptom is generated due to the dissolution characteristics are different.

Because the spraying process generates many spatters, and ink can accumulate at the corners of products, ink is wasted and the manufacturing costs are increased. Coating ink usually contains heavy metals so that it may not meet the rules restricting the use of hazardous substances (ROFS) and damage the environment.

Therefore, an in-mold decoration (IDM) process is developed to improve the described drawbacks. A resin with a protective effect and an extendable effect is applied on the external layer of the film. On the internal layer of the film, a printing method is used for processing the color, and heat forming or vacuum forming is used for forming the cubic structure of the products. The formula of the resin can be changed according to the requirements. In order to achieve the requirement of high hardness of the external protection layer, a high hardness inorganic oxide with nano or micrometer dimension is added to the resin. Although the additive can increase the hardness and enhance the anti-wear effect, the additive weakens the extendable effect and the forming effect. The touch feeling is rough.

Moreover, the product with tissue-type feeling of the prior art is processed by a complex manufacturing process, such as the corona process, a static electricity nap-planting process, or a process of pasting nap material onto the plastic substrate. The cost is high and the manufacturing process is complex and time-consuming. The worse problem is that the connection between the flexible nap layer and the plastic substrate is bad.

### SUMMARY OF THE INVENTION

One particular aspect of the present invention is to provide a film structure. A coating layer with flexible resin particles is applied on the film so that the film has a tissue-type feeling and enhances the anti-wear characteristic.

Another particular aspect of the present invention is to provide a manufacturing method for a film structure. A coating layer with flexible resin particles is applied on the surface of the film so that the film with a tissue-type feeling and the anti-wear characteristic can be easily and rapidly manufactured.

The film structure of the present invention is applied to the in-mold decoration process. The film structure includes a film, a coating layer and a plastic substrate located below the film. The coating layer includes a colloid and at least two kinds of flexible resin particles. The colloid is located at the upper surface of the film. The two kinds of flexible resin particles include the first resin particles for increasing the tissue-type feeling and the second resin particles for enhancing the anti-wear effect. The first resin particles and the second resin particles are disposed in the colloid.

The manufacturing method for a film structure is applied to the in-mold decoration process, and includes the following steps. A film is provided. At least two kinds of flexible resin particles are applied on the upper surface of the film. An ink layer is formed on the lower surface of the film. A heating process is used for forming the film into a pre-determined shape. An injection molding process is used for forming a plastic substrate, and the plastic substrate is pasted below the ink layer. Finally, UV light is used for hardening the coating layer.

The present invention has the following characteristics. The present invention adds the flexible resin particles to make the film have the tissue-type feeling so that the touch feeling of the product is good. Furthermore, because the resin particles are flexible, the scratching mark is not easily generated on the film. It can enhance the anti-wear effect, and prevent the film from fading to maintain the appearance of the product. Comparing to the manufacturing process of the prior art, the manufacturing process is simplified, and its cost is reduced.

For further understanding of the invention, reference is made to the following detailed description illustrating the embodiments and examples of the invention. The description is for illustrative purpose only and is not intended to limit the scope of the claim.

### BRIEF DESCRIPTION OF THE DRAWINGS

The drawings included herein provide a further understanding of the invention. A brief introduction of the drawings is as follows:

FIG. 1 is a cross-sectional view of the film coated with a coating layer of the present invention;

FIG. 2 is a cross-sectional view of the lower surface of the film formed with an ink layer of the present invention;

FIG. 3 is a cross-sectional view of the film molded by a heating process of the present invention;

FIG. 4 is a cross-sectional view of the plastic substrate molded under the ink layer by an injection molding method of the present invention; and

FIG. 5 is a flow chart of the manufacturing method for a film structure of the present invention.

### DETAILED DESCRIPTION OF THE PREFERRED EMBODIMENTS

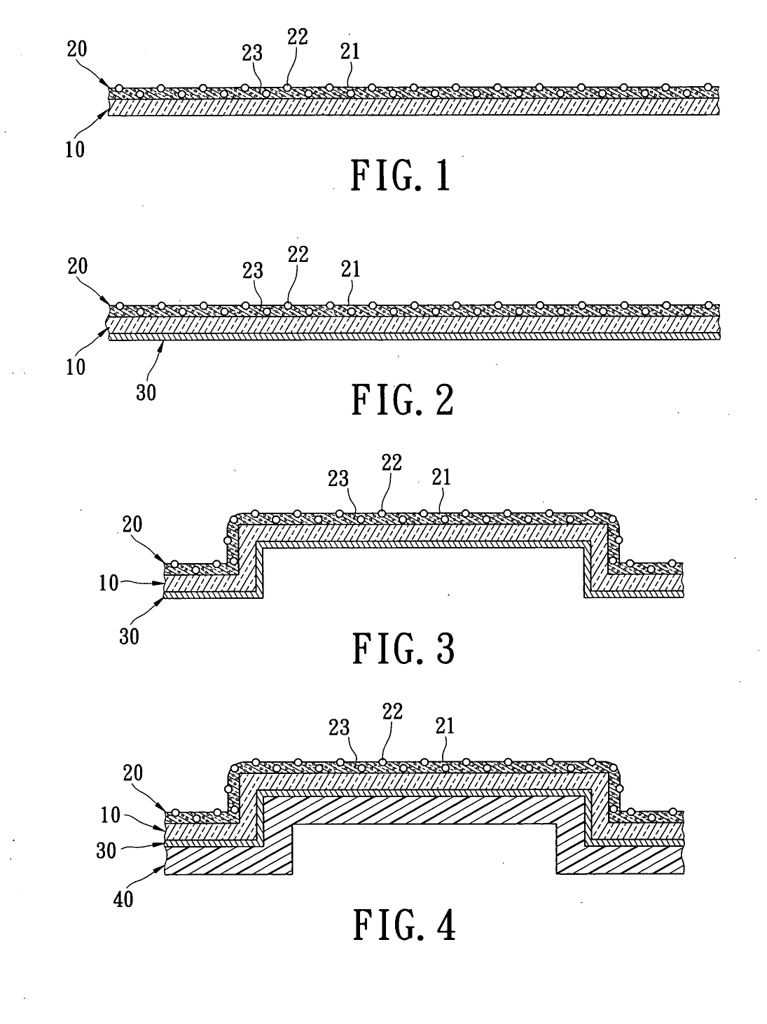

Reference is made to FIGS. 1˜4. The film structure of the present invention can be applied to the in-mold decoration manufacturing process and used as the housing of 3C electronic equipment, the decoration of car, the housing of car audio, the housing of toy, the joystick of TV game player, keyboard, mouse, handle, the housing of handle, etc. It can be applied to the products that need a colored decoration or a 3D decoration and the good touch feeling. The film structure includes a film 10, a coating layer 20, an ink layer 30, and a plastic substrate 40.

The film 10 is transparent and its thickness is 80˜500 μm. The film 10 is made of PMMA, PC, PET, PE, PVE, PP, PS, MS, TAC or COC.

The coating layer 20 includes a colloid 21 and at least two kinds of flexible resin particles. The colloid 21 is applied on the upper surface of the film 10 by slot coating, wire coating, roll coating, spray plating, or dip plating, etc. The thickness of the colloid 21 is 2˜50 μm. The colloid 21 is made of transparent resin, a diluted solvent (such as methyl ethyl ketone, acetic ester), a photoinitiator, a hardening assistant, a flow assistant and a bubble-eliminating assistant which are stirred and mixed. The transparent resin can be thermo plastic resin, thermoset resin, UV hardening resin, oligomer or monomer. In this embodiment, the transparent resin is UV hardening resin. The UV hardening resin includes PMMA acrylic resin, acrylic polyol resin, PMDI assistant, and the monomer with a circular structure.

The two kinds of flexible resin particles include first resin particles 22 and second resin particles 23. The first resin particles 22 and the second resin particles 23 can be PU particles, PC particles, PMMA particles, PS particles, MS particles, silica particles, or silicone particles.

The first resin particles 22 are used for enhancing the tissue-type feeling. The diameters of the first resin particles 22 can be equal or unequal. The diameters of the first resin particles 22 are between 1 μm and 100 μm. The ratio of the first resin particles 22 to the colloid 21 is 0.1˜40%.

The second resin particles 23 are used for improving the anti-wear effect. The diameters of the second resin particles 23 can be equal or unequal. The diameters of the second resin particles 23 are smaller than the diameters of the first resin particles 22. The diameters of the second resin particles 23 are between 5 nm and 100 nm. The ratio of the second resin particles 23 to the colloid 21 is 0.1˜40%.

The first resin particles 22 and the second resin particles 23 are disposed in the colloid 21. In one preferred embodiment, the ratio of the first resin particles 22 and the second resin particles 23 to the colloid 21 is 0.2˜60%.

The ink layer 30 is a multi-line or 3D figure, and is printed on the lower surface of the film 10 by a multi-color film or by 3D ink printing.

The plastic substrate 40 is made of PMMA, PC, PET, PP, PS, MS, ABS, POM, or nylon. The plastic substrate 40 is located below the ink layer 30 by injection molding so that the ink layer 30 is located between the film 10 and the plastic substrate 40.

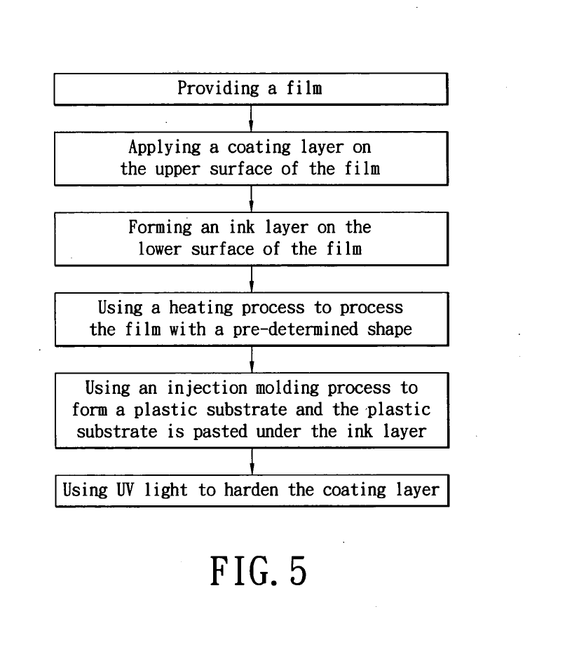

Reference is made to FIG. 5, which shows a manufacturing method for a film structure applied to the in-mold decoration manufacturing process. In this embodiment, the manufacturing method for a film structure is used for producing the housing of a cell phone that has a good anti-wear effect and a tissue-type feeling. The manufacturing method for a film structure includes the flowing steps (please also refers to FIGS. 1-4).

(a) Providing a transparent film 0. In this embodiment, the film 10 is a PC film and its thickness is 300 μm.

(b) Dispensing a colloid 21. A UV hardening resin is selected. The UV hardening resin includes PMMA acrylic resin, acrylic polyol resin, PMDI assistant, and the monomer with a circular structure, and is 60% of the colloid 21. The diluted solvent (such as methyl ethyl ketone, acetic ester, respectively 10% and 20% of the colloid 21) is added. The photoinitiator, hardening assistant, flow assistant and bubble-eliminating assistant make up 5% of the colloid 21. All are stirred and mixed to form the colloid 21.

(c) Two kinds of flexible resin particles (first resin particles 22 and second resin particles 23) are added with organic solvent. The first resin particles 22 (diameters are 2˜23 μm) for enhancing the tissue-type feeling and the second resin particles 23 for improving the anti-wear effect (diameters are 5˜18 nm) are added with organic solvent. The solvent can be a solvent having a high volatility, such as ethanol, isopropanal, acetone, methyl ethyl ketone, ethyl acetate, butyl acetate, etc. The ratio of the first resin particles 22 and the second resin particles 23 to the solvent is 1:1 so that the first resin particles 22 and the second resin particles 23 are moistened and uniformly disposed in the solvent.

(d) The moistened first resin particles 22 and the second resin particles 23 and the colloid 21 are stirred and mixed. The moistened first resin particles 22 and the second resin particles 23 are added to the colloid 21, and stirred by the homogenizer with 20 minutes and oscillated by ultrasonic waves with 30 minutes to make the first resin particles 22 and the second resin particles 23 be disposed in the colloid 21.

(e) A coating layer 20 is applied on the upper surface of the film 10. The colloid 20 with the first resin particles 22 and the second resin particles 23 are applied on the upper surface of the film 10 by a roller to form the coating layer 20 on the upper surface of the film 10. Its thickness is 20 μm. Alternatively, the coating layer 20 also can be formed by slot coating, wire coating, coating, spray plating, or dip plating.

(f) The coating layer 20 is heated until the coating layer 20 is in a non-sticky status. The coating layer 20 is dried with 5˜30 minutes so that the solvent in the colloid 21 is vaporized. The surface of the coating layer 20 is dry, non-sticky and extendable.

(g) A protection film is provided on the upper surface of the coating layer 20. The upper surface of the coating layer 20 is pasted with a protection film.

(h) Forms an ink layer 30 on the lower surface of the film 10. A multi-line or 3D figure (the ink layer 30) is printed on the housing of the cell phone by a multi-color film or by 3D ink printing.

(i) Takes off the protection film on the upper surface of the film 10.

(j) Forms the film 10 to a pre-determined shape for the housing of the cell phone by a heating process. The pre-shape for the housing of the cell phone is formed by a high-pressure heating process or by vacuum molding.

(k) A plastic substrate 40 is molded by injection molding and is pasted below the ink layer 30. The pre-shaped film 10 is placed into the injection mold, and performs an injection molding to form a ABS plastic substrate 40 so that the ABS plastic substrate 40 is formed and pasted on the ink layer 30.

(l) Uses UV light to harden the coating layer 20. Finally, the coating layer 20 is performed by a UV hardening process. The emitting power of the UV light is 500˜3000 mj/cm². Thereby, the housing of the cell phone with a high hardness, an excellent anti-wear effect and a comfortable tissue-type feeling is produced.

Reference is made to table 1, which shows the information of samples with different ratios and diameters of the resin particles.

TABLE 1

| | First | | | Second | | Second |
|---|---|---|---|---|---|---|
| | resin | First resin | First resin | resin | Second resin | resin |
| Ratio wt % | particles | particles | particles | particles | particles | particles |
| sample | 2~23 μm | 32~56 μm | 72~98 μm | 5~18 nm | 36~54 nm | 68~92 nm |
| Sample 1 | 30% | | | | | |
| Sample 2 | | 30% | | | | |
| Sample 3 | | | 30% | | | |
| Sample 4 | 25% | | | 5% | | |
| Sample 5 | 25% | | | | 5% | |
| Sample 6 | 25% | | | | | 5% |
| Sample 7 | 25% | | | 10% | | |
| Sample 8 | 25% | | | 15% | | |
| Sample 9 | 25% | | | 20% | | |
| Sample 10 | 30% | | | 5% | | |
| Sample 11 | 20% | | | 10% | | |
| Sample 12 | 10% | | | 20% | | |

Reference is made to table 2, which shows test results of the samples.

TABLE 2

| Test Item | | | | | |
|---|---|---|---|---|---|
| Sample | Hardness | Adhesion | ΔHaze | Elongation | Soft touch |
| Sample 1 | 3B | 5B | 5.73 | □ | □ |
| Sample 2 | 2B | 5B | 4.25 | □ | ◯ |
| Sample 3 | B | 5B | 3.49 | □ | □ |
| Sample 4 | H | 5B | 0.84 | □ | □ |
| Sample 5 | H | 5B | 1.05 | ◯ | ◯ |
| Sample 6 | H | 5B | 1.12 | ◯ | □ |

Excellent: □
Good: ◯
Normal: □
Not Good: X

TheΔHaze is the test result of the haze variation measured by transmittance haze measure after the testing sample is rubbed by a steel nap with a weight 100 g. The elongation is the result of the testing sample being tested by IMD molding machine with a mold that its height is 40 mm and its R value is 0.4 mm.

The standard for the table 2 is described as followings.

Excellent: means that the main plane area and the corner area are well formed.

Good: means that the main plane area is well formed, and the corner area has wrinkles or has the white mist symptom.

Normal: means that the main plane area is well formed, and the corner area has a great amount of wrinkles or is cracked.

Not Good: means that both the main plane area and the corner area have a great amount of wrinkles or are cracked

From the test result of table 2, the soft touch is good when merely the first resin particles 22 are added, especially when the diameter of the first resin particles 22 is 2˜23 μm. However, the hardness and theΔHaze are bad. After the second resin particles 23 are added, the hardness and theΔHaze are improved. Its attachment effect is not affected. Its soft touch is affected little, especially when the diameter of the second resin particles 23 is 5˜18 nm.

Reference is made to table 3, which shows test results of the samples.

TABLE 3

| Test Item | | | | | |
|---|---|---|---|---|---|
| Sample | Hardness | Adhesion | ΔHaze | Elongation | Soft touch |
| Sample 4 | H | 5B | 0.84 | □ | □ |
| Sample 7 | H | 5B | 0.72 | ◯ | ◯ |
| Sample 8 | H | 5B | 0.54 | □ | □ |
| Sample 9 | 2H | 5B | 0.18 | X | □ |
| Sample 10 | H | 5B | 0.92 | ◯ | □ |
| Sample 11 | H | 5B | 0.63 | ◯ | ◯ |
| Sample 12 | 2H | 5B | 0.09 | ◯ | X |

Excellent: □
Good: ◯
Normal: □
Not Good: X

From the test result of table 3, when the first resin particles 22 with a ratio over 20% are added, the soft touch is good. When the second resin particles 23 with a ratio over 5% are added, the hardness and theΔHaze are good. When the second resin particles 23 with a ratio over 10% are added, the soft touch becomes worse. When the first resin particles 22 and the second resin particles 23 with a total ratio over 40% are added, the elongation becomes worse, and the IMD molding effect is worse.

The present invention adds at least two kinds of flexible resin particles into the compound colloid that contains the thermo plastic, the thermoset or UV hardness resin, and coats the compound colloid on the upper surface of the film. The film structure and the manufacturing method can be applied to the in-mold decoration manufacturing process.

By using the resin semi-hardening process, a film with a dry surface, a good elongation, a tissue-type feeling and a good anti-wear effect are produced. By processing the film with the ink color-process heating process and the molding process with a high elongation, the surface of the film does not have the mold-escaping symptom or the crack symptom. By processed by the injection mold process and the UV lighting process to harden the surface of the film, the surface of the products has the tissue-type feeling and the anti-wear effect that can protect the color of the appearance. The manufacturing process for producing the film with a flexible tissue-type is simplified and its cost is reduced.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A film structure, applied to an in-mold-decoration process, comprising:
a film;
a coating layer having a colloid and at least two kinds of flexible resin particles, wherein the colloid is located at the upper surface of the film, the two kinds of flexible resin particles include the first resin particles for increasing the tissue-type feeling and the second resin particles for enhancing the anti-wear effect, and the first resin particles and the second resin particles are disposed in the colloid; and
a plastic substrate located below the film.

2. The film structure as claimed in claim 1, wherein the film is made of PMMA, PC, PET, PE, PVE, PP, PS, MS, TAC or COC.

3. The film structure as claimed in claim 1, wherein the colloid of the coating layer includes transparent resin, and the transparent resin is PMMA acrylic resin, acrylic polyol resin, PMDI assistant, or a monomer.

4. The film structure as claimed in claim 1, wherein the diameters of the first resin particles are 1˜100 μm, and the mass ratio of the first resin particles to the colloid is 0.1˜40%.

5. The film structure as claimed in claim 1, wherein the diameters of the second resin particles are 5˜100 nm, whereby the first resin particles can have identical diameters or be of different diameters, and the mass ratio of the second resin particles to the colloid is 0.1˜40%.

6. The film structure as claimed in claim 1, wherein the total mass ratio of the first resin particles and the second resin particles to the colloid is 0.2˜60%, and the first resin particles and the second resin particles are PU particles, PC particles, PMMA particles, PS particles, MS particles, silica particles, or silicone particles.

7. The film structure as claimed in claim 1, wherein the plastic substrate is made of PMMA, PC, PET, PP, PS, MS, ABS, POM, or nylon.

8. The film structure as claimed in claim 1, further comprising an ink layer, the ink layer being located between the film and the plastic substrate, and the ink layer being a multi-line or 3D figure, and being printed onto the lower surface of the film by a multi-color film or by 3D ink printing.

9. A manufacturing method for a film structure, applied to the in-mold decoration process, comprising:
providing a film;
applying a coating layer with at least two kinds of flexible resin particles on the upper surface of the film and heating the coating layer to render it non-sticky;
forming an ink layer on the lower surface of the film;
using a heating process to form the film into a pre-determined shape;
using an injection molding process to form a plastic substrate, and the plastic substrate is pasted below the ink layer; and
hardening the coating layer by UV light.

10. The manufacturing method for a film structure as claimed in claim 9, wherein the emitting power of the UV light for the step of hardening the coating layer is 500˜3000 mj/cm².
